(19) United States
(12) Patent Application Publication
(10) Pub. No.: US 2015/0158177 A1
(43) Pub. Date: Jun. 11, 2015

(54) PIPETTING ROBOT

(71) Applicant: Pius Fink, Hombrechtikon (CH)

(72) Inventor: Pius Fink, Hombrechtikon (CH)

(73) Assignee: SIAS AG, HOMBRECHTIKON (CH)

(21) Appl. No.: 14/407,176

(22) PCT Filed: Jun. 11, 2012
(86) PCT No.: PCT/EP2012/060967

§ 371 Date: Jan. 14, 2015

(51) Int. Cl. B25J 9/16; G01N 35/10; G01N 35/00

(52) U.S. Cl. CPC B25J 9/1671; B25J 9/1679; G01N 35/0099; G01N 35/10

(57) ABSTRACT

The invention concerns a method of manufacturing a pipetting robot adjusted for desired operation, a method of controlling said pipetting robot, a method of fault diagnostics for said pipetting robot, a method of programming said pipetting robot, a pipetting robot system, and a computer program product. This is achieved with the provision on a computer of a simulation of the pipetting robot with control inputs simulated, and responding identically to the pipetting robot on receipt of identical control signals.

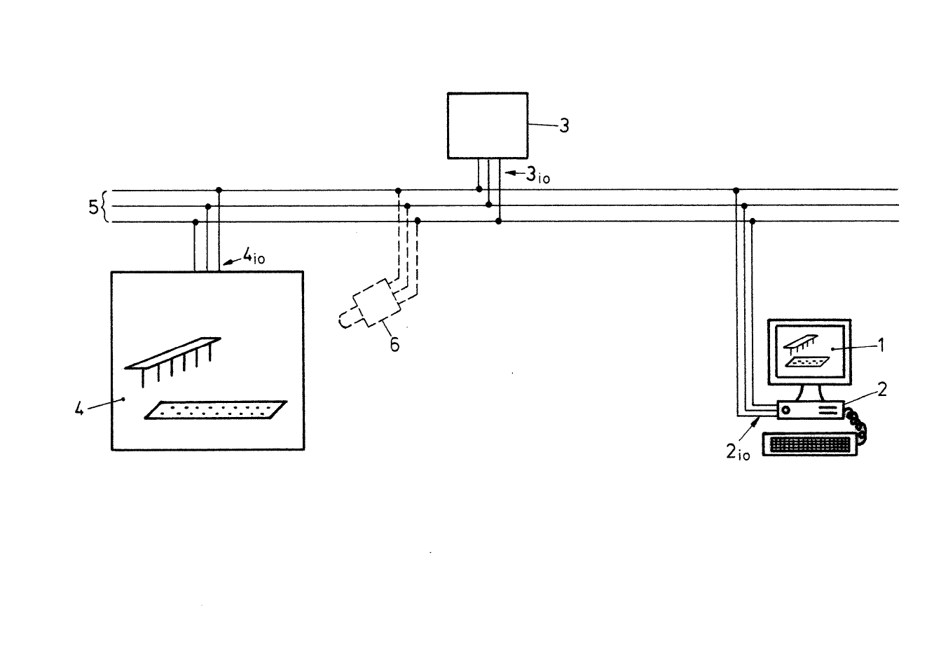

The present invention concerns a method of manufacturing a pipetting robot adjusted for desired operation, a method of controlling said pipetting robot, a method of fault diagnostics for said pipetting robot, a method of programming said pipetting robot, a pipetting robot system, and a computer program product for operating a pipetting robot manufactured according to the above-mentioned manufacturing method.

Pipetting robots are used in chemical and biochemical laboratories for automation of various tasks. In their simplest form they are automated machines for transporting fluid from one holder or reservoir into another. This simplest form utilises a motorised pipette or nozzle for fluid. Current pipetting robots are typically more complicated and are arranged so as to serve a plurality of sample holders simultaneously or sequentially, for instance by following a Cartesian coordinate programme. According to the needs of the user, such pipetting robots can be further equipped with additional laboratory devices, such as centrifuges, microplate readers, heating elements, cooling elements, stirrers, agitators, barcode readers, various analysis devices, incubators, and so on.

Complex pipetting robots can automatically carry out entire laboratory processes, and are often available for purchase in a modular form, that is to say that the client can specify which particular individual components are desired and in which configuration, and the pipetting robot can be constructed accordingly. In this manner, pipetting robots can be adapted to specific user needs. This unfortunately requires a large number of different modules to be available at any one time. Additionally to this, it is often required for the manufacturer to configure a pipetting robot according to the requirements of the user in relatively short period of time. The user must, however, wait for the construction of the pipetting robot to be completed before optimisation of the control parameters can be started, and before various control programs required to operate the machine can be developed. It should further be noted that one and the same hardware configuration may require several different software configurations according to the user's requirements.

It is thus the object of the present invention to provide a method of manufacturing a pipetting robot so as to be able to reduce the delivery time of such a pipetting robot, and/or to be able to provide an optimised method of controlling a pipetting robot, and/or to be able to pre-programme a pipetting robot that is in the planning stage, and/or to assist in fault diagnostics of a pipetting robot.

At least one of the above objects of the invention is achieved by a method of manufacturing a pipetting robot adjusted for desired operation, comprising:

a) providing a pipetting robot with control inputs for control signals controlling operation of the pipetting robot, that is to say constructing or manufacturing a physical pipetting robot;

b) providing on a computer a simulation of said pipetting robot with control inputs simulated (i.e. possessing “simulated control inputs”), e.g. by generating a computer simulation based on a physics model of the above-mentioned pipetting robot (i.e. generating a “simulated pipetting robot”). Control signals are generated, and are applied to, i.e. are sent to, the simulated control inputs of the simulated pipetting robot and are adjusted to simulate desired operation of the pipetting robot on the simulated pipetting robot. In short, the simulated pipetting robot is arranged to mimic the pipetting robot, and to respond in the same manner to control signals;

c) applying the control signals to the control inputs of the pipetting robot, i.e. transmitting identical control signals to the simulated pipetting robot and to the pipetting robot. Steps a) and b) are performed in the following sequence:

a) before b), which is the case in which the pipetting robot has already been constructed; or

a) and b) overlapping, i.e. construction and development of the pipetting robot and the simulated pipetting robot are carried out at least partly simultaneously, which permits speedier development of e.g. control programs for the pipetting robot while it is still under construction without having to wait for it to be completed; or

a) after b), and performing step c) after step b), which permits the development of control programs for a pipetting robot that is still in the planning stage.

In an embodiment, applying the control signals to the physical and/or simulated pipetting robot is performed via a remote communication network, which enables the simulated control signals to be generated remotely, e.g. by a control unit, remote software library, remote computer terminal or similar.

In an embodiment, the pipetting robot comprises signal outputs for output signals (such as status messages, position-related signals and so on) generated by the pipetting robot, and the computer simulation of the pipetting robot, i.e. the simulated pipetting robot, comprises simulation of the outputs of the pipetting robot and of the output signals of the pipetting robot, and wherein the simulated output signals are equal to the output signals of the pipetting robot. In other words, given the same status of the pipetting robot and of the simulated pipetting robot, the same physical signals are output by both. Thus if a control signal for the pipetting robot is a voltage pulse of 1 ms at a voltage level of 1 V, the corresponding control signal for the simulated pipetting robot lasts 1 ms at a voltage level of 1 V. The same prevails for the addressed equal output signals. Thus to a control unit, both the pipetting robot and the simulated pipetting robot will appear to give identical output signals.

Furthermore, at least one of the above-mentioned objects of the invention is achieved by a method of controlling a pipetting robot comprising the steps of manufacturing a pipetting robot according to any of the above embodiments, and communicating at least by identical control signals with both the pipetting robot and with the simulated pipetting robot. This enables, amongst other things, (remote) control of the pipetting robot with simultaneous visualisation by means of the simulated pipetting robot, although the control does not have to be simultaneous, i.e. it can be time-shifted. In this latter case, for instance, a technician can apply a series of control signals to the simulated pipetting robot, and if they cause desired operation e.g. without collisions at the simulated robot or incorrect metering of fluids, and so on, then the technician can send the same control signals to the pipetting robot so as to cause it to carry out the addressed desired operation. Alternatively, sequences of control signals successfully developed on the simulated pipetting robot can be stored, e.g. in the form of a control program, and later sent to the pipetting robot to carry out desired operations.

In an embodiment, the sequence of control signals is stored in an electronic storage system in the form of a control program, thus forming a computer program product according to the present invention. This electronic storage system can be storage local to the pipetting robot and/or the computer upon which the simulated pipetting robot is running, or in a remote storage system such as a remote computer terminal, remote software library, or equivalent.

Furthermore, at least one above-mentioned object of the invention is achieved by a method of fault diagnostics for a pipetting robot comprising controlling the pipetting robot according to the above-mentioned method of controlling, and then diagnosing the fault at least with the help of the simulated pipetting robot. In other words, a fault, such as a collision or an incorrectly metered amount of fluid, noted at the pipetting robot can be diagnosed by sending the same control signals leading to such fault to the simulated pipetting robot, enabling visualisation of the operation of the pipetting robot on the simulated pipetting robot and thereby fault diagnostics of the pipetting robot.

In an embodiment, both the pipetting robot and the simulated pipetting robot are simultaneously sent the control signals, which are identical for both the simulated pipetting robot and the physical pipetting robot, to permit real-time fault diagnostics on the simulated pipetting robot by means of a technician and/or an automated algorithm.

In an embodiment, the control signals are sent to the pipetting robot and the simulated pipetting robot at different times, which is particularly advantageous in the case that control signals that were previously causing problematic operation of the pipetting robot are then later sent to the simulated pipetting robot for “off-line” fault diagnostics by a technician and/or an automated algorithm to diagnose the fault without having to have the pipetting robot operate and thereby possibly risking damage thereto.

In an embodiment, the sequence of control signals is stored in an electronic storage system in the form of a control program, i.e. forming a computer program product according to the present invention. This electronic storage system can be a storage local to the pipetting robot and/or to the computer upon which the simulated pipetting robot is running, or in a remote storage system such as a remote computer unit, remote software library unit, or similar.

In an embodiment, status messages generated in the pipetting robot are sent to the simulated pipetting robot. This provides further information as to the status of the pipetting robot which is useful in fault diagnostics.

Furthermore, at least one of the above-mentioned objects of the invention is achieved by a method of programming a pipetting robot comprising the steps of manufacturing a pipetting robot according to any of the above-mentioned embodiments of manufacturing; programming the simulated pipetting robot, thereby generating a control program; generating control signals in dependency of said control program and applying said control signals to the pipetting robot. This enables programming of the pipetting robot via programming the simulated pipetting robot, enabling operating programs for the pipetting robot even to be prepared before the pipetting robot has been constructed as an alternative to the cases in which the pipetting robot has already been constructed or is still in construction. This can significantly reduce delivery time for a pipetting robot by enabling the programming to be done at least partially in advance of completion of the pipetting robot.

In an embodiment, the control program (i.e. the computer program product) is stored in electronic storage system, which can be storage local to the pipetting robot and/or the computer upon which the simulated pipetting robot is running, or in a remote storage system such as a remote computer terminal, remote software library, or equivalent.

In an embodiment, the control program is applied to a control module of the pipetting robot. This control module can then translate the control program into the control signals for controlling the pipetting robot.

Still further, at least one of the above-mentioned objects of the invention is achieved by a pipetting robot with control inputs for control signals controlling operation of the pipetting robot; a computer simulation of said pipetting robot (i.e. a simulated pipetting robot) in which said control inputs are simulated (i.e. possessing simulated control inputs); a control signal generator, such as a control unit, which outputs the control signals. The control signal generator may be local to either the pipetting robot or the simulated pipetting robot, or remote e.g. in the form of a remote computer terminal. The outputs of the control signal generator are operationally connected to both said control inputs of the pipetting robot and said simulated control inputs of the simulated pipetting robot.

This provides a structure for carrying out at least one of the above-mentioned methods.

Finally, the invention relates to a computer program product for operating a pipetting robot manufactured according to any of the above-mentioned manufacturing methods.

The invention will be further exemplified by means of specific, non-limiting embodiments as illustrated schematically in the sole FIGURE, which shows a pipetting robot system.

In the FIGURE, a simulated pipetting robot 1 has been generated on a computer 2. The simulated pipetting robot 1 is “mechanically” identical to a corresponding physical pipetting robot 4, that is to say all movable components of the physical pipetting robot 4 are modelled and simulated in the simulated pipetting robot 1. The simulated pipetting robot 1 is controlled by control signals passed to it from a control unit 3, which may be local to—as in integrated in—the computer 2, or local to the pipetting robot 4, or situated remote from both, e.g. at a remote computer. In each case, the control unit 3 generates control signals e.g. by running a control program, or via a man-machine interface directly thereat and/or at computer 2. These control signals cause the carrying-out of respective actions of the pipetting robot. Such control signals may cause the pipetting robot to move to, for instance, destination coordinates, pipette a specified volume of fluid or pipette at a specified flow rate, etc. If necessary, the initial setup of the simulated pipetting robot 1 and/or the pipetting robot 4 may be performed by sending parameter-defining signals as control signals thereto such that it will react in a desired manner upon receipt of the control signals.

The control signals are transferred via an interface 5, which may be of any known type such as a USB interface, a synchronous or asynchronous serial bus, the Internet or Ethernet, a Controller Area Network bus, a fibre-optic link, and so on. Each of the computer 2, control unit 3 and pipetting robot 4 are connected with the interface 5, via respective input and output ports 2io, 3io and 4io.

The response of the simulated pipetting robot 1 to the control signals is the same as that of a corresponding physical pipetting robot 4. Internal system signals and status messages generated in the simulated pipetting robot 1 are likewise identical to those generated in physical pipetting robot 4, and these are passed to the control unit 3 via respective input and output ports 2io, 3io and 4io, and can be used for feedback control of the pipetting robot 4 and/or of the simulated pipetting robot 1. In consequence, the control unit 3 is “blind” as to whether it is transmitting signals to the simulated pipetting robot 1 or to the physical pipetting robot 4, since the signals transmitted and received are identical. Likewise as above, if necessary, the initial setup of the pipetting robot 4 can be carried out by sending parameter signals as control signals thereto that are identical to the parameter signals sent to the simulated pipetting robot 1, thereby ensuring that the pipetting robot 4 will equally respond in the desired manner upon receipt of control signals. The control unit 3 records in a log file the sequence of control signals sent to the pipetting robot 4 and/or the simulated pipetting robot 1, and can also record in the same or a different log file internal system signals and/or status messages generated by the pipetting robot 4 and/or the simulated pipetting robot 1 and transmitted to the control unit 3.

To aid in visualisation, CAD/CAM information can be incorporated into the simulated pipetting robot e.g. to allow a technician to visualise the movements thereof, and for manual or automatic collision detection.

As a result, it is possible to utilise the illustrated setup for pre-programming a physical pipetting robot 4 that is still in the planning phase: the simulated pipetting robot 1 is configured to accurately represent the intended physical pipetting robot 4 based on modelling and previous experience, and programs can be developed by technicians without the physical pipetting machine yet having been built. These programs can then be stored and later transferred to the pipetting robot once it has been constructed, either by loading them directly into a control module of the pipetting robot itself, or into a separate control unit 3 that may be e.g. a remote computer, software library unit, or similar. The system can, of course, be used likewise to program a pre-existing or partially constructed pipetting robot.

It is also possible to use the illustrated system for simultaneous control of a simulated pipetting robot 1 and of a physical pipetting robot 4. In this case, simulated pipetting robot 1 may be visualised on a computer monitor either locally or remote to the pipetting robot 4. Control unit 3 transmits command signals simultaneously to both the pipetting robot 4 and the simulated pipetting robot 1. The simulated pipetting robot 1 can incorporate the full functionality of the pipetting robot 4, representing all its degrees of freedom. The command signals can be transmitted via any type of interface connection 5, as e.g. described above. The particular advantage of this arrangement is that it enables simultaneous visualisation of the operation of the pipetting robot, without requiring feedback of information therefrom. This is useful e.g. for fault diagnostics, in which case a technician can watch the visualisation of the simulated pipetting robot 1 on a monitor, for instance remotely, and thereby diagnose any problems with the programming of the pipetting robot 4 without having to be physically present with the pipetting robot 4 itself. Indeed, for such fault diagnostics it is not even necessary that the pipetting robot 4 is operated simultaneously with the simulated pipetting robot 1: sending the control signals that had previously been sent to the pipetting robot 4 and recorded in a log file to the simulated pipetting robot 1 enables off-line fault diagnostics directly, in other words it permits playback on the simulated pipetting robot 1 of the actions previously performed on the pipetting robot 4. This is particularly advantageous in the case in which the fault with the programming is so serious that there is a risk of damaging the pipetting robot or allied equipment, since this can be then diagnosed and resolved on the simulated pipetting robot without risking damage to the physical robot.

In the case in which the simulated pipetting robot 1 comprises means for collision detection, fault diagnostics can be carried out at least partially automatically, e.g. by means of a collision detection algorithm.

Furthermore, to assist in fault diagnostics, the pipetting robot 4 can send also status signals to the control unit 3, which can store them as mentioned above in a log file for later diagnosis or playback, and possible comparison with equivalent status signals generated by simulated pipetting robot 1.

Further extensions of the concept include the following:
a video capture device 6 such as a digital video camera may be arranged to view the pipetting robot 4 such that its movements can be remotely viewed and compared with the movements of the simulated pipetting robot 1. This may be advantageous in cross-checking whether the similar to robot in fact behaves like the physical robot, for instance by superimposing video captured by the video capture device 6 with a corresponding visualisation of the simulation on a screen. Such a video capture device can interface directly with the control unit 3 or computer 2, or may interface to either or both of these via remote communication network 5 (as illustrated in dotted lines in the FIGURE);
a plurality of pipetting robots 4 controlled by a single control unit 3, with the same or different control signals being sent to each pipetting robot 4;
use of the simulated pipetting robot 1 for technician training, by for instance incorporating visualisation of assembly, disassembly and maintenance of the simulated pipetting robot. Additional to this, technical handbook information may be incorporated into this visualisation, permitting step-by-step guidance for technicians for assembly, disassembly, fault finding, and so on.

Several examples of operation will now be described:

1. An Example of Controlling the Pipetting Robot for a Desired Operation.

A set of parameters are sent to the simulated pipetting robot as control signals. The virtual operation of the simulated pipetting robot 1 is then followed and checked by a technician. The parameters and/or control signals are then adjusted as necessary to cause the simulated pipetting robot 1 to carry out the desired operation. The same control signals are then transmitted to the physical pipetting robot 4 to cause it to carry out the desired operation. If desired, the addressed control signals can be simultaneously transmitted to the simulated pipetting robot 1 so that a technician can monitor the status and movements of the physical pipetting robot 4 in real-time on the computer 2. The sequences of control signals developed as above may be expressed in the form of a control program and stored either in the computer 2, in the control unit 3, or a control module of the physical pipetting robot 4.

2. An Example of Fault Diagnostics for the Pipetting Robot

In this example, we assume that the physical pipetting robot 4 is not performing as desired, that is to say is carrying out an undesired operation.

The control signals causing the undesired operation of the physical pipetting robot 4, e.g. generated in dependency of a control program, or regenerated based on a log file in control unit 3 or computer 2, are then transmitted to the simulated pipetting robot 1, and a technician can observe the behaviour of the simulated pipetting robot 1. Automated algorithms such as collision detection algorithms may assist in this process. Once the fault has been identified, the technician can then take corrective action by modifying the sequence of control signals, e.g. by modifying a control program. The thus modified control signals can then be transmitted to the physical pipetting robot 4 as above.

3. An Example of Programming a Pipetting Robot.

A simulated pipetting robot 1 is generated as described above on computer 2. This simulated pipetting robot can simulate an already-existing pipetting robot, or be based on a client specification so as to simulate a pipetting robot according to the client's needs that will be constructed in the future or is already in the construction phase. A technician then programs the simulated pipetting robot 1 to carry out desired operations, thereby generating a control program in dependence of which control signals are generated. Once the pipetting robot 4 is completed if the it has not already been done so, the control program can be run either on control unit 3, on computer 2, or on a control module integrated into pipetting robot 4, thereby generating control signals in dependency of the control program, the signals being transmitted to the pipetting robot 4 to cause it to carry out the desired operation.

4. An Example of Error-Recovery Testing for a Pipetting Robot.

A simulated pipetting robot 1 is deliberately put into an “incorrect” state, that is to say an unintended state such as one in which parts are in collision. By doing so, error-recovery programming routines, i.e. sequences of instructions intended to take the pipetting robot back into a desired state, can be tested on the simulated pipetting robot without having to risk damage to the corresponding physical pipetting robot. The error recovery programming routines for the pipetting robot can then be adjusted to ensure that they run correctly first on the simulated pipetting robot.

Although the invention has been described with reference to specific embodiments, it is clear to the skilled person the variations are possible without deviating from the scope of the invention as defined in the appended claims.

1. A method of manufacturing a pipetting robot adjusted for desired operation, comprising the steps of:
a) providing a pipetting robot with control inputs for control signals controlling operation of the pipetting robot;
b) providing on a computer a simulation of said pipetting robot with said control inputs simulated, generating control signals and applying said control signals to said simulated control inputs of said simulated pipetting robot and adjusting said control signals so as to simulate desired operation of the pipetting robot on said simulated pipetting robot;
c) applying said control signals to said control inputs of said pipetting robot;
wherein steps a) and b) are performed in the following sequence:
a) before b); or
a) and b) overlapping; or
a) after b), and performing step c) after step b).

2. The method according to claim 1, wherein said applying said control signals to said pipetting robot and/or to said simulated pipetting robot is performed via a remote communication network.

3. The method according to claim 1, wherein said pipetting robot comprises signal outputs for output signals generated by said pipetting robot, and said computer simulation of said pipetting robot comprises simulation of said outputs and of said output signals, wherein said simulated output signals are equal to said output signals.

4. The method of controlling a pipetting robot comprising:
manufacturing a pipetting robot according to claim 3;
communicating at least by identical control signals with both the pipetting robot and with the simulated pipetting robot.

5. The method according to claim 1, wherein the sequence of control signals is stored in an electronic storage system in the form of a control program.

6. The method of fault diagnostics for a pipetting robot comprising:
controlling the pipetting robot according to the method of claim 5;
diagnosing the faults by means of at least the simulated pipetting robot.

7. The method according to claim 1, wherein identical control signals are sent to the simulated pipetting robot and to the pipetting robot simultaneously, or at different times.

8. The method according to claim 1, wherein the sequence of control signals is stored in an electronic storage system in the form of a control program.

9. The method according to claim 8, wherein status messages generated in the pipetting robot are sent to the electronic storage system and/or to the simulated pipetting robot.

10. The method of programming a pipetting robot (4) comprising the steps of:
manufacturing a pipetting robot according to claim 3;
programming the simulated pipetting robot, thereby generating a control program;
generating control signals in dependency of said control program, and applying said control signals to the pipetting robot.

11. The method according to claim 1, wherein the control program is stored in an electronic storage system.

12. The method according to claim 11, wherein said control program is applied to a control module of the pipetting robot.

13. A pipetting robot system comprising:
a pipetting robot with control inputs for control signals controlling operation of the pipetting robot;
a computer simulation of said pipetting robot in which said control inputs are simulated;
a control signal generator with outputs for control signals; wherein the outputs of the control signal generator are operationally connected to both said control inputs of the pipetting robot and said simulated control inputs of the simulated pipetting robot.

14. A computer program product for operating a pipetting robot manufactured according to the method of claim 3.
